(19) United States
(12) Patent Application Publication
(10) Pub. No.: US 2015/0013953 A1
(43) Pub. Date: Jan. 15, 2015

(54) FLUID CONDUIT SYSTEMS

(71) Applicant: HELIOFOCUS, LTD., NESS ZIONA (IL)

(72) Inventors: Eli Mandelberg, Tel-Aviv (IL); Hagay Kafri, Bet-Hashmonay (IL); Oren Michael Gadot, Nes-Ziona (IL); Yanir Blumenthal, Kfar-Saba (IL); Haim Brudo, Kibbutz Givat Brenner (IL)

(21) Appl. No.: 14/375,438

(22) PCT Filed: Feb. 3, 2013
(86) PCT No.: PCT/IL13/00011

§ 371 Date: Jul. 30, 2014

Related U.S. Application Data
(60) Provisional application No. 61/594,361, filed on Feb. 2, 2012.
(60) Provisional application No. 61/594,350, filed on Feb. 2, 2012.

(51) Int. Cl. F28D 7/00; F16L 9/18

(52) U.S. Cl. CPC F28D 7/00; F16L 9/18
USPC 165/164; 138/148

(57) ABSTRACT

A fluid conduit system, including a central fluid channel having an entrance for a working fluid flowing in a first direction at one end and an exit for the working fluid at an opposite end, a circumferential fluid channel surrounding the central fluid channel adapted for receiving the working fluid exiting the central fluid channel and directing the working fluid in a second direction opposite the first direction, at least one device positioned in the central fluid channel for having the working fluid flow therethrough, and fluid communication between the device and outside the circumferential fluid channel, wherein thermal energy supplied by the working fluid is used by a thermal energy consumption system.

### CROSS REFERENCE TO RELATED APPLICATIONS

This application claims priority to U.S. Provisional Patent Application No. 61/594,350, filed Feb. 2, 2012 and, entitled “Fluid Conduit Assemblies” and U.S. Provisional Patent Application No. 61/594,361, filed Feb. 2, 2012 and entitled “Fluid Conduit Assemblies and Systems Thereof”. The disclosures of the above applications are incorporated herein by reference in their entirety.

### TECHNICAL FIELD

The present application generally relates to fluid conduit systems.

### BACKGROUND

Fluid conduits systems may be used for transferring thermal energy of a working fluid from a thermal energy source to a thermal energy consumption system. Examples of thermal energy sources are fossil-fuel systems and renewable energy systems. Examples of renewable energy systems are solar energy systems, geothermal energy systems, wind or wave energy systems.

In conventional fluid conduit systems various devices are provided. These devices are configured to allow flow of the working fluid therethrough for utilizing the thermal energy of the working fluid. An example of such a device is a heat exchanger, which may be used to transfer the thermal energy of the working fluid to the thermal energy consumption system. Another device may be thermal energy storage which is used to store the thermal energy of the working fluid therein.

Conventionally, these devices are places in the ambient environment and are subjected to heat losses to the ambient environment and pressure differences formed due to the difference of a pressure within the device and the ambient pressure of the ambient environment.

### SUMMARY

The details of one or more variations of the subject matter described herein are set forth in the accompanying drawings and the description below. Other features and advantages of the subject matter described herein will be apparent from the description and drawings, and from the claims.

There is thus provided in accordance with an embodiment of the present disclosure a fluid conduit system, including a central fluid channel having an entrance for a working fluid flowing in a first direction at one end and an exit for the working fluid at an opposite end, a circumferential fluid channel surrounding the central fluid channel adapted for receiving the working fluid exiting the central fluid channel and directing the working fluid in a second direction opposite the first direction, at least one device positioned in the central fluid channel for having the working fluid flow therethrough, and fluid communication between the device and outside the circumferential fluid channel, wherein thermal energy supplied by the working fluid is used by a thermal energy consumption system.

In some embodiments, the system may further include at least a portion of a layer of thermal insulation between the central fluid channel and the circumferential fluid channel. The system may further include at least a portion of a layer of thermal insulation between the working fluid and an ambient environment.

In some embodiments, the device may include a heat exchanger assembly. The device may include a thermal storage assembly. The device may include a thermal storage assembly and a heat exchanger assembly. The system may further include a bypass channel for allowing the working fluid to bypass the heat exchanger assembly. The device may include at least one of: a thermal storage assembly, a heat exchanger assembly, a steam boiler, a heat recovery steam generator, a furnace, a pressure vessel or a reactor vessel.

In some embodiments, the working fluid includes a gas, air, helium, carbon dioxide, a liquid, oil, water, steam, an organic fluid or molten salt. A heat transfer fluid may be provided to transfer the thermal energy from the working fluid to the thermal energy consumption system. The heat transfer fluid may include a gas, air, helium, carbon dioxide, a liquid, oil, water, steam, an organic fluid or molten salt.

In some embodiments, the fluid communication outside of the circumferential fluid channel may be with a thermal energy source provided to heat the working fluid. The thermal energy source may include a solar energy system. The thermal energy consumption system may include a steam turbine, a vapor turbine, a gas turbine, an industrial system, a vapor consuming process, a dryer, a solid desiccant system, or an absorption refrigerator.

In some embodiments, the system may further include a control system for controlling flow of the working fluid within the fluid conduit system.

In some embodiments, the fluid conduit assembly may be configured for having the working fluid flow around the device.

There is thus provided in accordance with an embodiment of the present disclosure a fluid conduit system, including a first channel having a closed end and an open end, a second channel positioned in the first channel, wherein the second channel has an entrance and an exit, wherein the exit is spaced apart from the closed end of the first channel, and at least one device positioned in the second channel having fluid communication outside of the fluid conduit system, wherein a working fluid introduced into the entrance of the second channel passes therethrough and out of the exit toward the closed end of the first channel and out of the open end.

In some embodiments, the system may further include at least a portion of a layer of thermal insulation between the second channel and the first channel. The system may further include at least a portion of a layer of thermal insulation between the working fluid and the ambient environment.

There is thus provided in accordance with an embodiment of the present disclosure a fluid conduit system, including a fluid channel having an entrance for a working fluid flowing in a first direction at one end and an exit for the working fluid at an opposite end, a device positioned in the fluid channel and configured for having the working fluid flow therearound, and fluid communication between the device and outside the fluid channel, wherein thermal energy supplied by the working fluid is used by a thermal energy consumption system.

In some embodiments, the system may further include an additional fluid channel surrounding the fluid channel adapted for receiving the working fluid exiting the fluid channel at a first direction and directing the working fluid in a second direction, opposite the first direction. The system may further include at least a portion of a layer of thermal insulation between the fluid channel and the additional fluid channel. The system may further include at least a portion of a layer of thermal insulation between the working fluid and an ambient environment. The device may include a heat exchanger assembly. The device may include a thermal storage assembly. The device may include a thermal storage assembly and a heat exchanger assembly. The system may further include a bypass channel for allowing the working fluid to bypass the heat exchanger assembly. The device may include at least one of a thermal storage assembly, a heat exchanger assembly, a steam boiler, a heat recovery steam generator, a furnace, a pressure vessel or a reactor vessel.

In some embodiments, the working fluid may include a gas, air, helium, carbon dioxide, a liquid, oil, water, steam, an organic fluid or molten salt. A heat transfer fluid may be provided to transfer the thermal energy from the working fluid to the thermal energy consumption system. The heat transfer fluid may include a gas, air, helium, carbon dioxide, a liquid, oil, water, steam, an organic fluid or molten salt.

In some embodiments, the fluid communication outside of the fluid channel may be with a thermal energy source provided to heat the working fluid. The thermal energy source may include a solar energy system. The thermal energy consumption system may include a steam turbine, a vapor turbine, a gas turbine, an industrial system, a vapor consuming process, a dryer, a solid desiccant system, or an absorption refrigerator.

In some embodiments, the system may further include a control system for controlling the flow of the working fluid within the fluid conduit system.

In some embodiments, the working fluid may flow through the device.

### BRIEF DESCRIPTION OF THE DRAWINGS

The principals and operation of the system, apparatus and methods according to embodiments of the present invention may be better understood with reference to the drawings, and the following description, it being understood that these drawings are given for illustrative purposes only and are not meant to be limiting.

FIG. 1 is schematic illustrations of a fluid conduit system according to some embodiments of the present disclosure;

FIG. 2 is an exemplary solar energy system comprising the fluid conduit system of FIG. 1;

FIGS. 3A-3C are schematic illustrations of another fluid conduit system according to some embodiments of the present disclosure, at a first, second and third operational mode, respectfully;

FIG. 4 is an exemplary solar energy system comprising the fluid conduit system of FIGS. 3A-3C;

FIGS. 5A-5C are schematic illustrations of yet another fluid conduit system according to some embodiments of the present disclosure, at a first, second and third operational mode, respectfully; and

FIG. 6 is an exemplary solar energy system comprising the fluid conduit system of FIGS. 5A-5C.

### DETAILED DESCRIPTION

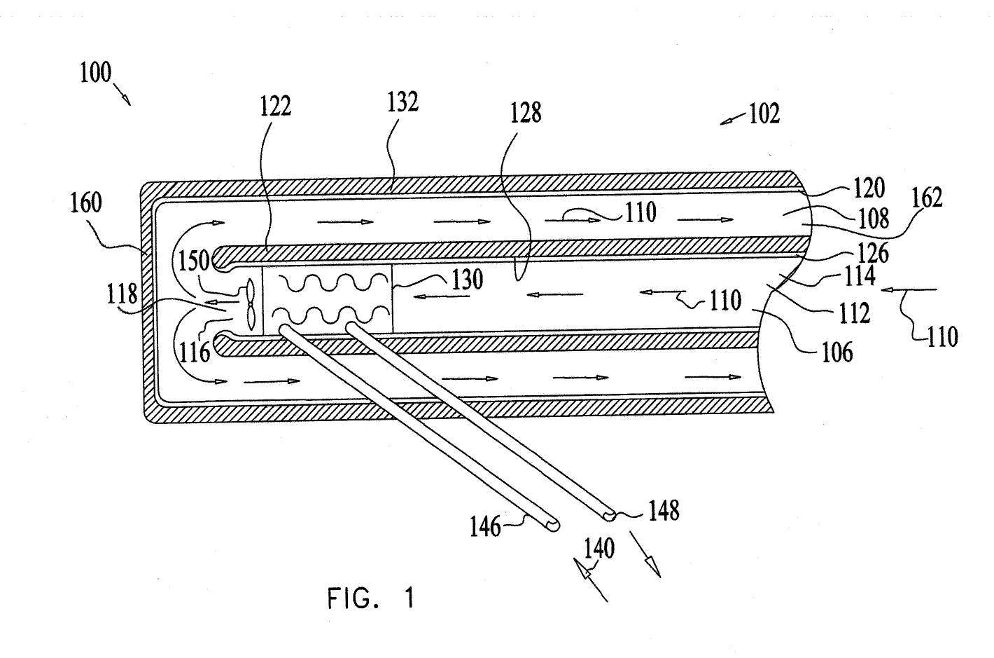

FIG. 1. is a schematic illustration of a fluid conduit system according to some embodiments of the present disclosure. As seen in FIG. 1, a fluid conduit system 100 comprises an annulus assembly 102. The annulus assembly 102 comprises a central fluid channel 106, surrounded by a circumferential fluid channel 108. The central fluid channel 106 and the circumferential fluid channel 108 may be generally coaxially aligned therebetween and are provided for flow of a working fluid 110 therethrough.

In some embodiments, as seen in FIG. 1, the central fluid channel 106 may comprise an entrance 112 thereto for allowing the working fluid 110 to enter therein and flow in a first direction at one end 114 thereof and the central fluid channel 106 may further comprise an exit 116 therefrom at an opposite end 118. The circumferential fluid channel 108 may be adapted for receiving the working fluid 110 exiting the central fluid channel 106 from exit 116 and directing the working fluid 110 in a second direction, opposite the first direction.

A circumferential pipe 120 may be provided around the circumferential fluid channel 108. The circumferential pipe 120 may be formed of any suitable material allowing relatively high temperature fluid to flow therethrough, such as in a range of 100-400 C.°. In a non-limiting example, the circumferential pipe 120 may be formed of carbon steel.

A central thermal insulation layer 122 may be provided between the central fluid channel 106 and the circumferential fluid channel 108 for thermally insulating the working fluid 110 flowing through the central fluid channel 106 and preventing heat exchange between the working fluid 110 flowing within the central fluid channel 106, generally at a first temperature and the working fluid 110 flowing within the circumferential fluid channel 108, generally at a second temperature.

In accordance with an embodiment, a central pipe 126 may be provided around the central fluid channel 106. The central pipe 126 may underlie the central thermal insulation layer 122, as seen in FIG. 1, or may overlie the central thermal insulation layer 122. The central pipe 126 may be formed of any suitable material allowing relatively high temperature fluid to flow therethrough, such as in a range of 150-1000 C.°. In a non-limiting example, the central pipe 126 may be formed of carbon steel or stainless steel.

In accordance with another embodiment, the central pipe 126 may not be provided and the working fluid 110 may flow in direct contact with an inner interior surface 128 of the central thermal insulation layer 122.

A circumferential thermal insulation layer 132 may be provided to insulate the working fluid 110 from the ambient environment. The circumferential thermal insulation layer 132 may overlie the pipe 120, as shown in FIG. 1, or at least a portion thereof, or may underlie the pipe 120 or at least a portion thereof. The central thermal insulation layer 122 and the circumferential thermal insulation layer 132 may be formed of any suitable insulating material, such as a microporous insulator or any suitable ceramic material, or multiple layers of different materials, for example.

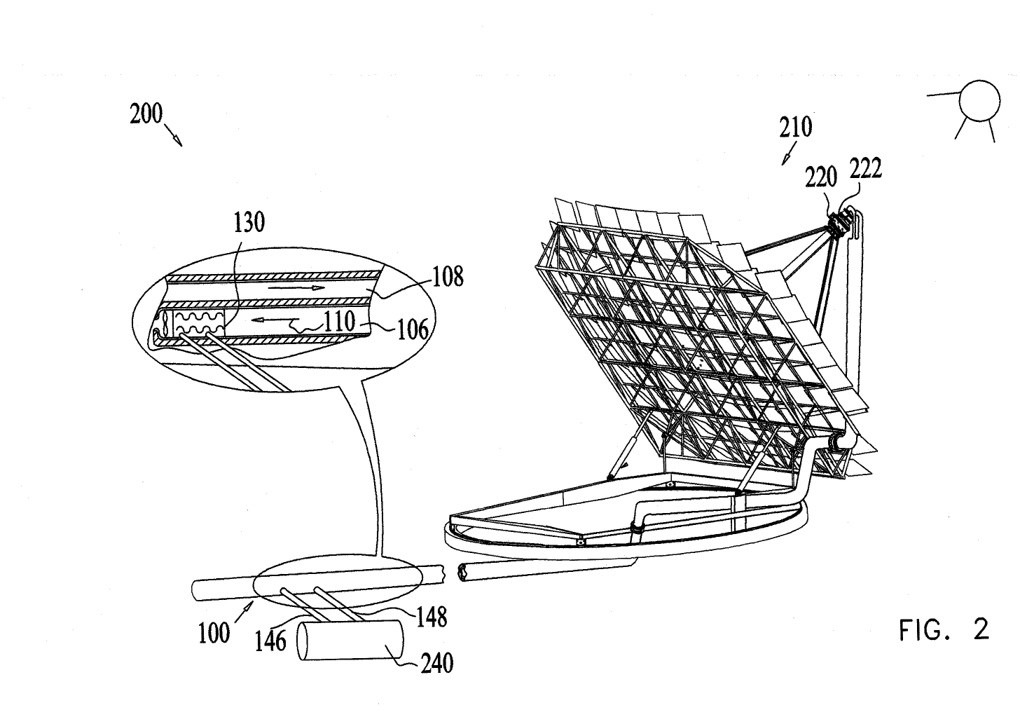

The working fluid 110 may be heated by a thermal energy source (not shown) to the first temperature, prior to entering the annulus assembly 102. The thermal energy source may be any source suitable for heating the working fluid 110 to the first temperature. In a non-limiting example, the thermal energy source may comprise a fossil-fuel system, a renewable energy system, such as a geothermal energy system, a wind energy system, a wave energy system, or a solar energy system. An exemplary solar energy system will be described in reference to FIG. 2.

Thermal energy of the working fluid may be provided to a thermal energy consumption system (not shown) for operation thereof. The thermal energy consumption system may comprise any thermal energy consumption system utilizing the working fluid 110, such as, for example, a steam turbine, a vapor turbine, a gas turbine, an industrial system, a vapor consuming process used in the chemical industry or other industries, a dryer, a solid desiccant system, or an absorption refrigerator. In the exemplary solar energy system of FIG. 2 the thermal energy consumption system comprises a steam turbine, as will be further described.

In some embodiments, the first temperature may be a working temperature, which may be any suitable range of temperatures allowing the thermal energy consumption system to operate. In some embodiments, the working temperature may be relatively high, such as in the range of 150-1000 C.°. In some embodiments, the first temperature may also be below the working temperature yet above an ambient temperature.

In some embodiments, the working temperature may be relatively cool and below the ambient temperature and may be used in thermal energy consumption systems that provide cooling, such as refrigerants or heating, ventilation and air conditioning systems (HVAC).

The working fluid 110 may comprise any suitable fluid, such as a gas, typically air, helium or carbon dioxide, or a liquid such as oil, water, an organic fluid or molten salt, for example.

The thermal energy of the working fluid 110 may be provided to the thermal energy consumption system in any suitable manner, such as by a heat exchanger assembly 130 or any other suitable device for providing the working fluid thermal energy to the thermal energy consumption system.

In some embodiments, the heat exchanger assembly 130 may comprise a plurality of heat exchangers therein, such as a preheater, a steam generator, and a superheater, for example.

In accordance with some embodiments, a heat transfer fluid 140 may flow into the heat exchanger assembly 130, via an inlet conduit 146, to be heated within the heat exchanger assembly 130 by the working fluid thermal energy and thus transfer the thermal energy to the thermal energy consumption system. The heated heat transfer fluid 140 may flow out of the heat exchanger assembly 130, via an outlet conduit 148, and may flow to the thermal energy consumption system. The inlet conduit 146 and outlet conduit 148 may access the heat exchanger assembly 130 in any suitable manner. For example, bores (not shown) may be formed in the respective central and circumferential thermal insulation layers 122 and/or 132, and/or respective central and/or circumferential pipes 120 and 126.

The heat transfer fluid 140 may be any suitable fluid, such as a gas, such as air, helium, carbon dioxide, a liquid, such as water, steam, molten salt, an organic fluid, and oil, for example.

The working fluid 110 may exit the heat exchanger assembly 130 at a second temperature. In some embodiments, when the first fluid temperature is relatively hot and above the ambient temperature, the second temperature may be lower than the first temperature, though still above ambient temperature. In some embodiments, when the first fluid temperature is relatively cool and below the ambient temperature, the second temperature may be higher than the first temperature, though lower than the ambient temperature.

A pump, fan or blower 150, or any other suitable device, may be provided for directing the now cooled working fluid 110 to flow from the heat exchanger assembly 130 out the exit 116 to the circumferential fluid channel 108.

The cooled working fluid 110 may flow through the circumferential fluid channel 108 and thereout. Wherein the fluid conduit system 100 is a closed-loop system, the cooler working fluid 110 may flow back to the thermal energy source for reheating thereof. Wherein the fluid conduit system 100 is an open-loop system, the cooler working fluid 110 may flow to any other location.

As described in the background, conventionally, the heat exchanger assembly 130 is placed in the ambient environment, out of the annulus assembly 102. In accordance with an embodiment of the present disclosure, as seen in FIG. 1, the heat exchanger assembly 130 is placed within the central fluid channel 106 of the annulus assembly 102. This provides many advantages, as will be now described. In the annulus assembly 102 the cooled working fluid 110 exits the heat exchanger assembly 130 and flows in the circumferential fluid channel 108 at the second temperature, which is above the ambient temperature. This cooled working fluid 110 significantly minimizes the heat losses from the hot working fluid 110 flowing in the central fluid channel 106 at the first temperature. Heat losses from the hot working fluid 110 to the ambient environment may also be minimized due to the central and circumferential thermal insulation layers 122 and 132. Similarly, by placing the heat exchanger assembly 130 within the central fluid channel 106 the heat losses from the heat exchanger assembly 130 are significantly less than the heat losses from a heat exchanger assembly 130 placed within the ambient environment. This is due to the above ambient temperature of the cooled working fluid 110 flowing in the circumferential fluid channel 108 at the second temperature, and may also be due to the central and/or circumferential thermal insulation layers 122 and 132.

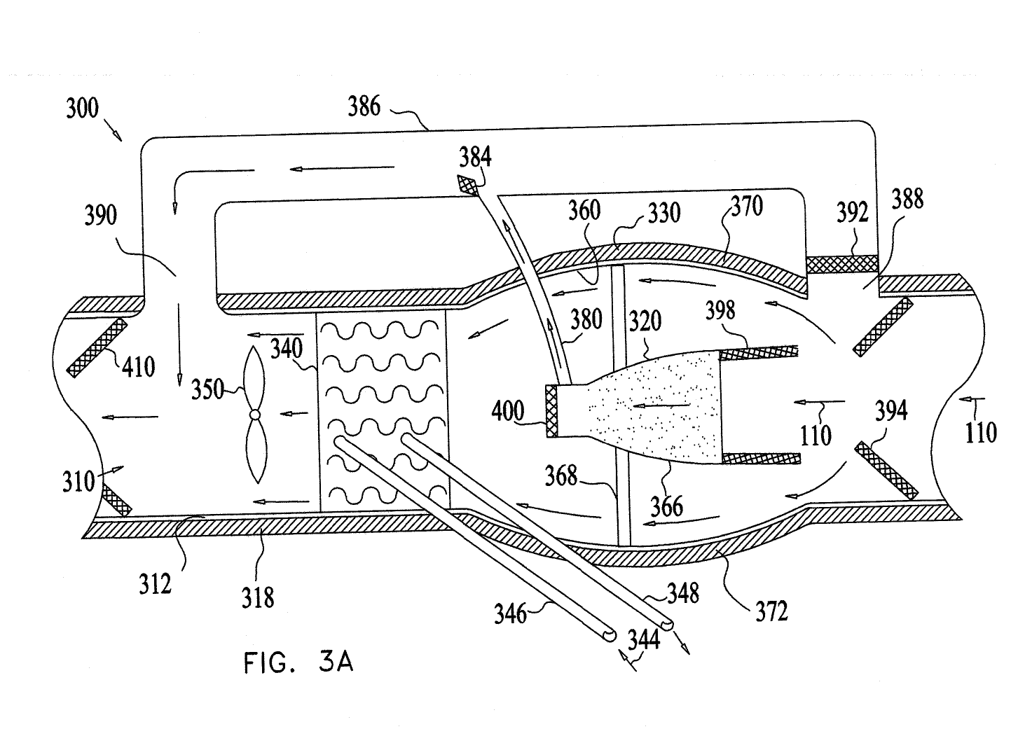

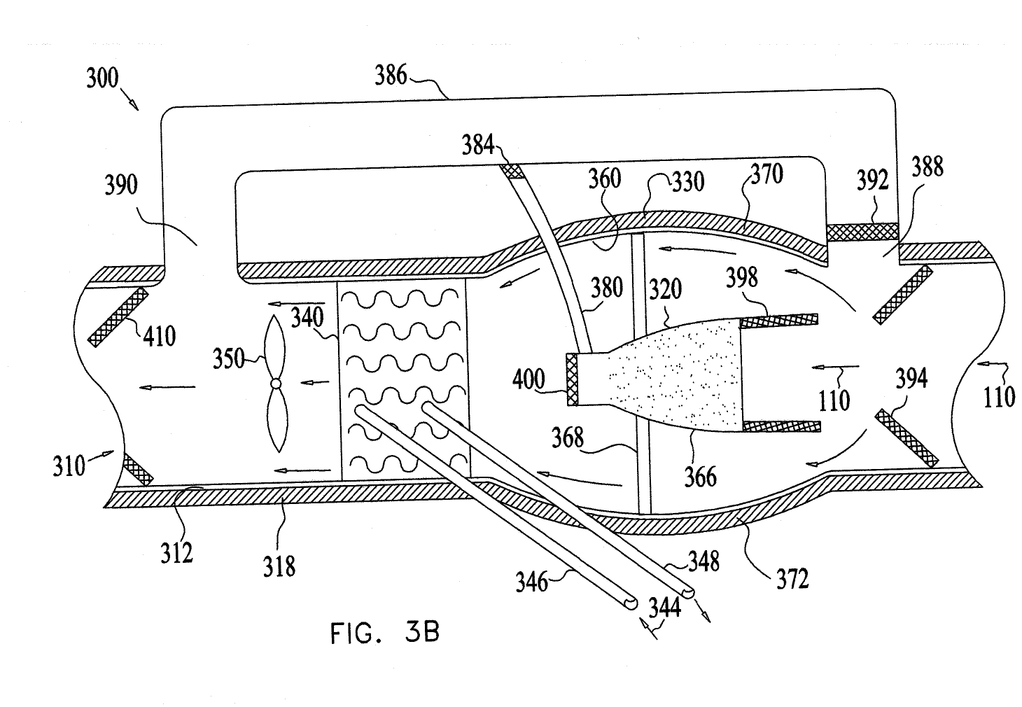

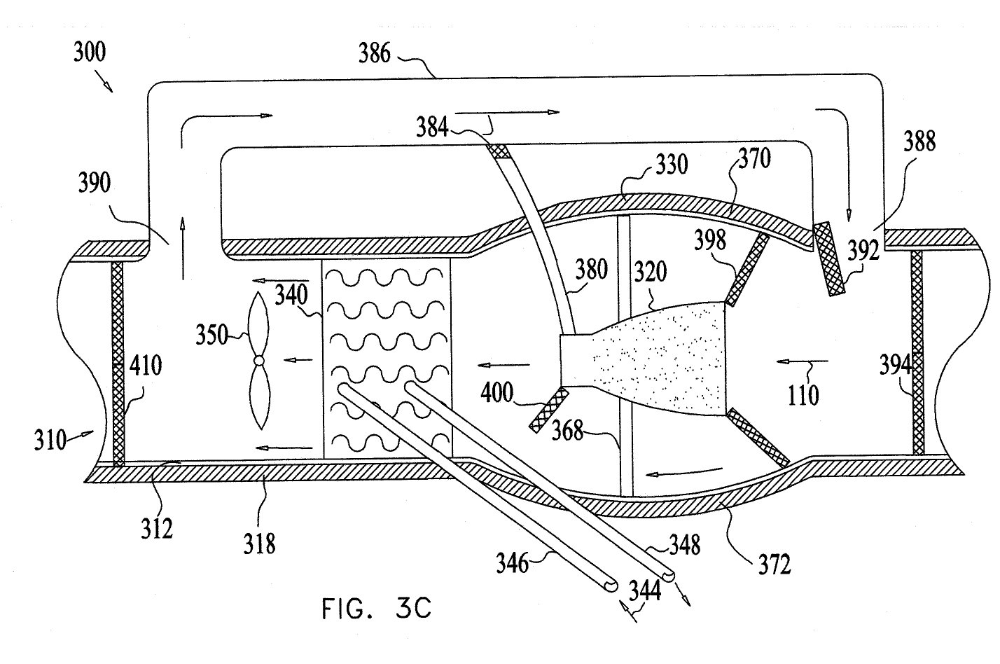

Additionally, there may be times when the thermal energy source is unable to heat the working fluid 110 to the first temperature, such as the working temperature. In some embodiments for example, wherein the thermal energy source is a solar energy system, this may occur at night. During these times, the heat exchanger assembly 130 may at times halt its operation and cease to provide thermal energy to the thermal energy consumption system. In other embodiments for example, also wherein the thermal energy source is a solar energy system, this may occur during operation, such as during the day, such as when the solar radiation diminishes due to cloudiness. At these times during operation, the heat exchanger assembly 130 may at times halt its operation and cease to provide thermal energy to the thermal energy consumption system or may utilize other heat sources, such as fossil fuel or may utilize stored thermal energy, such as the thermal storage assembly of FIGS. 3A-6. Nevertheless, substantially at all times, the temperature of the working fluid 110 within the circumferential fluid channel 108 still remains above ambient temperature, due to the circumferential thermal insulation layer 132. Accordingly, the heat losses from the heat exchanger assembly 130 are still significantly less than the heat losses from a heat exchanger assembly 130 placed within the ambient environment.

Moreover, when the thermal energy source resumes to heat the working fluid 110 to the first temperature, such as the working temperature, the temperature within the heat exchanger assembly 130 may be raised to the working temperature for allowing the heat exchanger assembly 130 to commence its operation. For example, wherein the heat exchanger assembly 130 comprises a shell and tube configuration, the heat exchanger tubes may be required to be heated to the working temperature in order to commence the operation thereof. Therefore, when the heat exchanger assembly 130 is placed in the central fluid channel 106, significantly less thermal energy from the working fluid 110 is required for raising the temperature within the heat exchanger assembly 130 to the working temperature, than the thermal energy required, when placed in the ambient environment.

Furthermore, as described above, within the annulus assembly 102 there is fluid communication between the working fluid 110 flowing in the central fluid channel 106 at the first temperature and the working fluid 110 flowing in the circumferential fluid channel 108 at the second temperature. Therefore the pressure difference between the working fluid 110 within the circumferential fluid channel 108 and the working fluid 110 within the central fluid channel 106 is substantially minimal or negligible. Accordingly, the pressure difference within the heat exchanger assembly 130 and the working fluid 110 within the central fluid channel 106 and the circumferential fluid channel 108 is substantially minimal or negligible and is significantly less than a pressure difference between the ambient environment and within a heat exchanger assembly 130 placed in the ambient environment.

Moreover, when placing the heat exchanger assembly 130 in the ambient environment, a fluid conduit is required to direct the working fluid 110 at the first temperature to flow from central fluid channel 106 to the heat exchanger assembly 130 and an additional fluid conduit is required to direct the working fluid 110 at the second temperature from the heat exchanger assembly 130 to the circumferential fluid channel 108. By placing the heat exchanger assembly 130 within the central fluid channel 106 both fluid conduits are unnecessary.

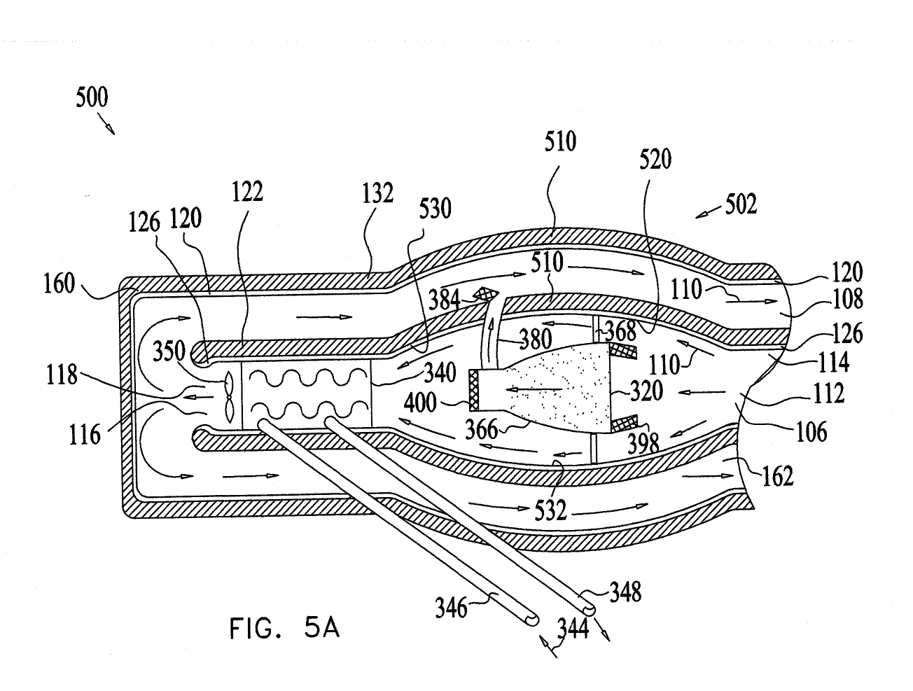

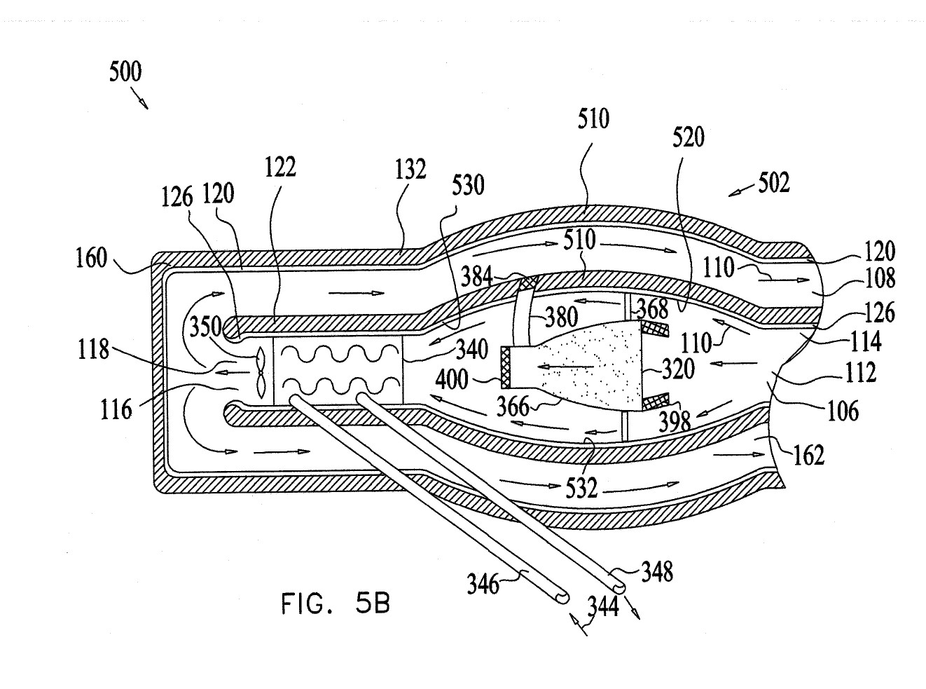

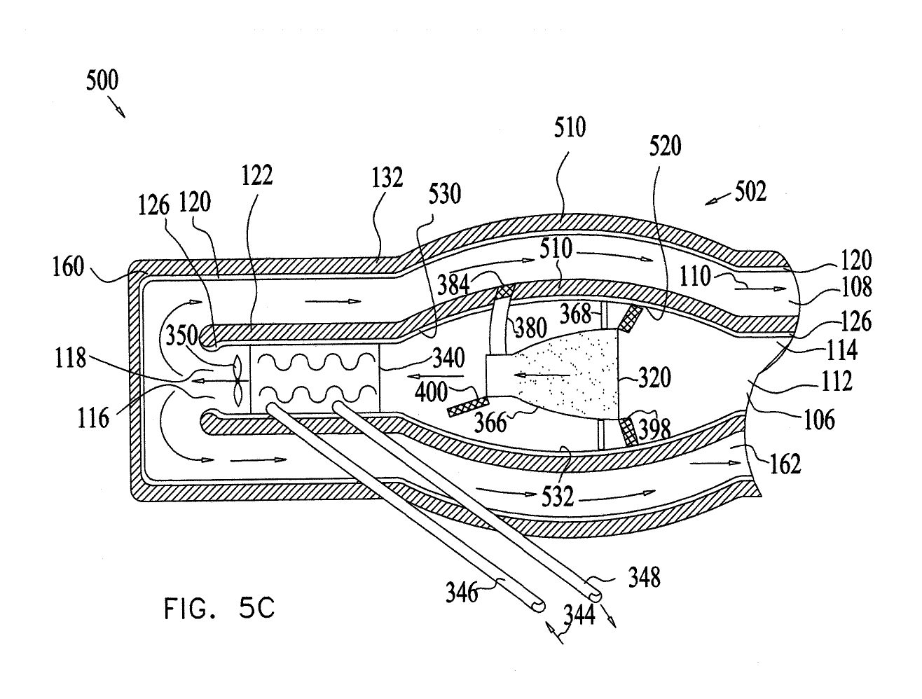

In some embodiments, additional devices may be provided within the annulus assembly 102 in addition to the heat exchanger assembly 130, as will be further described in reference to FIGS. 5A-5C.

In accordance with an embodiment of the present disclosure, any suitable device may be placed within the annulus assembly 102 in place of the heat exchanger assembly 130 or in addition thereto. Such a device may be configured to utilize the thermal energy of the working fluid 110 for any selected operation. The device, when placed within the central fluid channel 106, losses less heat than when being placed in the ambient environment. The pressure difference within the device and the working fluid 110 is substantially minimal or negligible and significantly less than a pressure difference between the ambient environment and within a device placed in the ambient environment.

In a non-limiting example, the device may be thermal energy storage provided to store thermal energy from the working fluid flowing therein at the first temperature. The stored thermal energy may be provided to the thermal energy consumption system in any suitable manner, such as by directing a fluid to flow therein via the inlet conduit 146 and to flow thereout to the thermal energy consumption system, via the outlet conduit 148. Other examples of a device may be a steam boiler, a heat recovery steam generator, a furnace, a pressure vessel or a reactor vessel.

As seen in the embodiment of FIGS. 1 and 2, wherein the device comprises the heat exchanger assembly 130, the selected operation may be providing thermal energy to the thermal energy consumption system. Wherein the device comprises thermal energy storage the selected operation may be storing the thermal energy of the working fluid 110 for use wherein the thermal energy source is unable to heat the working fluid 110 to the working temperature.

In some embodiments, the device may use the thermal energy of the working fluid 110 for a selected operation unrelated to the thermal energy consumption system. For example, wherein the thermal energy source is a solar energy system and the thermal energy consumption system is a steam turbine, the device may comprise a chemical reactor and may be used for performing a chemical reaction unrelated to the steam turbine.

In some embodiments, the circumferential fluid channel 108 may be defined as a first channel comprising a closed end 160 and an open end 162. The central fluid channel 106 may be defined as a second channel positioned in the first channel, wherein the second channel comprises the entrance 112 and the exit 116, and wherein the exit 116 is spaced apart from the closed end 160 of the first channel. The device is positioned in the second channel and is in fluid communication with outside of the fluid conduit system 100. The working fluid 110 introduced into the entrance 112 of the second channel passes therethrough and out of the exit 116 toward the closed end 160 of the first channel and out of the open end 162.

In some embodiments, there may be fluid communication between the device and outside the circumferential fluid channel 108. For example, as described herein, the working fluid 110 may be heated by the thermal energy source to the first temperature and that heated working fluid 110 may flow through the device. The device may be configured to utilize the thermal energy of the working fluid 110 for any selected operation. The thermal energy utilized by the device may be used for the selected application and may be provided by fluid communication between the working fluid 110 and the selected application. For example, as described, wherein the selected application is providing thermal energy to the thermal energy consumption system, the thermal energy may be provided to the thermal energy consumption system by transferring heat from the working fluid 110 to the heat transfer fluid 140 within the heat exchanger assembly 130.

In some embodiments, the devices may be placed substantially in proximity to the inner surface 128, as shown in FIG. 1, wherein the heat exchanger assembly 130 is placed in proximity to the inner surface 128. In some embodiments, the devices may be placed within the central fluid channel 106 at a distance from the inner surface 128 for allowing the working fluid 110 to flow therearound, as will be further described in reference to FIGS. 3A-6.

The devices may be mounted in the central fluid channel 106 in any suitable manner. For example, the heat exchanger assembly 130 may be harnessed to the inner surface 128 at any suitable location.

The devices may be placed in any suitable location along the central fluid channel 106. In some embodiments, the devices may be placed within the circumferential fluid channel 108.

In some embodiments, apparatuses (not shown) for controlling the operation of the devices and flow of the working fluid 110 may be provided. For example, temperature and pressure sensors may be provided to measure the temperature of the working fluid 110 within the device or within the annulus assembly 102. Additional apparatuses, such as the blower 150, pumps, valves, shutters or dampers may be provided to control the flow of the working fluid 110 within the annulus assembly 102 and the devices and control the flow of the heat transfer fluid 140 within the inlet conduit 146 and outlet conduit 148. These apparatuses may be electrically or mechanically operated or in any other suitable manner and may communicate with a control system (not shown) in any suitable manner. The control system may be placed out of the annulus assembly 102, or may be placed within the annulus assembly 102.

In a non-limiting example, wherein the apparatuses are electrically operated, an electrical conduit comprising electrical wires (not shown), may be inserted within bores formed in the respective central and circumferential thermal insulation layers 122 and 132, and/or respective central and circumferential pipes 120 and 126 for providing electrical communication between the apparatuses within the annulus assembly 102 and with the control system, when placed out of the annulus assembly 102.

Reference is now made to FIG. 2, which is an exemplary solar energy system comprising the fluid conduit system 100 of FIG. 1. In FIG. 2 the thermal energy source is a solar thermal energy system 200, which may comprise a solar concentrator 210. The solar concentrator 210 may be a solar concentrator system described in PCT publication WO/2010/067370 which is incorporated herein in its entirety by reference. The solar concentrator 210 may be any suitable concentrator, such as a dish, as shown in FIG. 2, or a heliostat, for example.

The solar concentrator 210 may be provided to concentrate sunlight impinging thereon and reflect the concentrated sunlight back to a predetermined focal location 220. Thermal energy of the concentrated light may be utilized to heat the working fluid 110, in any suitable manner. For example, in the embodiment shown in FIG. 2, a solar receiver 222 may be mounted at focal location 220. The solar receiver 220 is provided to heat the working fluid 110 therein by utilizing the thermal energy of the concentrated light.

Hot working fluid 110 exits the receiver 222 and may flow into the central fluid channel 106 at the first temperature. In a non-limiting example, the hot working fluid 110 flows in the central fluid channel 106 at a range of 400-1000° C., such as 600° C. The hot working fluid 110 may flow to the heat exchanger assembly 130, which may use the thermal energy of the hot working fluid 110 to heat the heat transfer fluid 140 flowing in the inlet conduit 146. In a non-limiting example, the heat transfer fluid 140 flows into the heat exchanger at a temperature of approximately 50° C. and is heated to a temperature of approximately 540° C. The heated heat transfer fluid 140 may flow out of the heat exchanger assembly 130, via the outlet conduit 148, to a thermal energy consumption system. As seen in FIG. 2, the thermal energy consumption system comprises a steam turbine 240. The heat transfer fluid 140 may flow back into the inlet conduit 146 from the steam turbine 240.

The now cooled working fluid 110 flows out of the heat exchanger assembly 130 at the second temperature. In a non-limiting example, the cooled working fluid 110 flows out of the heat exchanger assembly 130 at temperature in a range of 100-350° C.

The cooled working fluid 110 may flow, via the circumferential fluid channel 108, back to the solar receiver 222, for being reheated therein, as shown in FIG. 2, or may flow to any other suitable location.

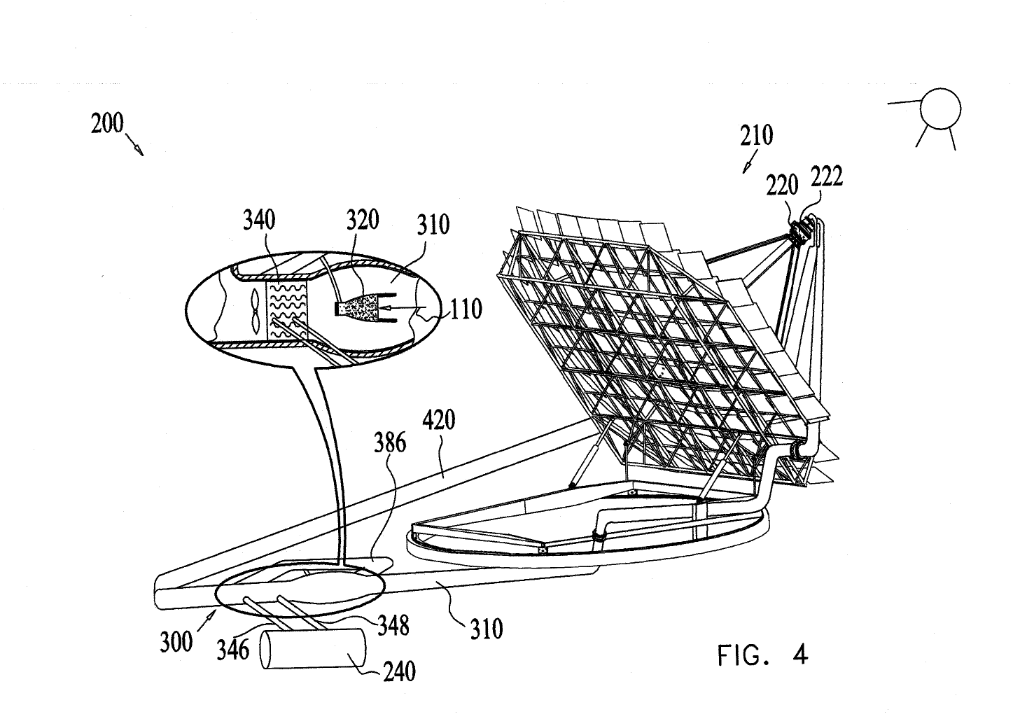

The embodiments of FIGS. 1 and 2 show exploiting: (i) the working fluid 110, which flows in the fluid conduit system 100 during the course of its operation (i.e. from the thermal energy source to the thermal energy consumption system and back), and exploiting (ii) an already existing thermally insulated fluid conduit system 100, for minimizing heat losses from the device, by placing the device within the annulus assembly 102. Similarly, the embodiments of FIGS. 3A-4 show exploiting (i) the working fluid 110, which flows in a fluid conduit system 300 during the course of its operation, and exploiting (ii) an already thermally insulated existing fluid conduit channel 310 for preventing heat losses from the device.

In the embodiments of FIGS. 1 and 2 the heat loss is minimized by the working fluid 110 flowing at the second temperature in the circumferential fluid channel 108 and by the central and circumferential thermal insulation layers 122 and 132. In the embodiments of FIGS. 3A-4 the heat loss is minimized by placing the device within the fluid channel 310 surrounded by a single pipe 312 and a thermal insulation layer 318. The working fluid 110 flowing within the fluid channel 310 and surrounding the device at an above ambient temperature, and the thermal insulation layer 318, minimize the heat loss from the device.

In FIGS. 3A-4, the device shown is thermal energy storage, i.e. a thermal storage assembly 320, though it is appreciated that any suitable device may be placed within the fluid channel 310 for minimizing the heat losses therefrom.

As seen in FIGS. 3A-3C, the fluid conduit system 300 comprises the fluid channel 310 surrounded by the pipe 312. The pipe 312 may be formed in any suitable configuration, such as a cylindrical pipe. The pipe 312 may bow out at a section 330 surrounding the thermal storage assembly 320 so as to allow the working fluid 110 to flow therearound. The pipe 312 may be formed of any suitable material, typically a material adapted to withstand relatively high temperatures, such as stainless steel, for example. It is appreciated that the pipe 312 may be formed without section 330 and the working fluid 110 may flow around the thermal storage assembly 320 in any suitable manner. For example, section 330 may be substantially straight and the pipe 312 may be sufficiently large to allow the working fluid to flow around a device within the fluid channel 310.

The thermal insulation layer 318 may be introduced between the pipe 312 and the ambient environment so as to minimize heat losses from the working fluid 110 to the ambient environment. As seen in FIGS. 3A-3C, the thermal insulation layer 318 overlies the pipe 312. In some embodiments, the thermal insulation layer 318 may underlie the pipe 312 or may be provided in any suitable location. The thermal insulation layer 318 may be formed of any suitable material such as a microporous insulator or any suitable ceramic material, or multiple layers of different materials for example.

The working fluid 110 may flow within the fluid channel 310 at a relatively high temperature, such as in the range of 150-1000° C., for example. The working fluid 110 may be heated by the thermal energy source to the first temperature, such as the working temperature, prior to entering the fluid conduit assembly 300. The thermal energy source may be any suitable source, as described in reference to FIGS. 1 and 2. An exemplary solar energy system will be described in reference to FIG. 4. Thermal energy of the working fluid 110 may be provided to the thermal energy consumption system for operation thereof, such as the thermal energy consumption system described in reference to FIGS. 1 and 2.

The thermal energy of the working fluid 110 may be provided to the thermal energy consumption system in any suitable manner, such as by a heat exchanger assembly 340 or any other suitable device for providing the working fluid thermal energy to the thermal energy consumption system.

In some embodiments, the heat exchanger assembly 340 may comprise a plurality of heat exchangers therein, such as a preheater, a steam generator, and a superheater, for example.

In accordance with some embodiments, a heat transfer fluid 344 may flow into the heat exchanger assembly 340, via an inlet conduit 346, to be heated within the heat exchanger assembly 340 by the working fluid thermal energy. The heated heat transfer fluid 344 may flow out of the heat exchanger assembly 340, via an outlet conduit 348, and may flow to the thermal energy consumption system. The inlet conduit 346 and outlet conduit 348 may access the heat exchanger assembly 340 in any suitable manner. For example, bores (not shown) may be formed in the thermal insulation layer 318, and pipes 312. It is noted that the heat transfer fluid 344 may be similar to heat transfer fluid 140 and the inlet conduit 346 may be similar to the inlet conduit 146 and the inlet conduit 348 may be similar to the inlet conduit 148.

The heat transfer fluid 344 may be any suitable fluid, such as a gas, air, water, steam, helium, molten salt, an organic fluid, oil, a liquid, and carbon dioxide, for example.

The working fluid 110 may exit the heat exchanger assembly 340 at the second temperature, which may be lower than the working temperature, though still above ambient temperature. A pump, fan or blower 350, or any other suitable device, may be provided for directing the now cooled working fluid 110 to flow from the heat exchanger assembly 340 thereout.

Wherein the fluid conduit system 300 is a closed-loop system, the cooler working fluid 110 may flow back to the thermal energy source for reheating thereof. Wherein the fluid conduit system 300 is an open-loop system, the cooler working fluid 110 may flow to any other location.

The heat exchanger assembly 340 may be in fluid communication with the thermal storage assembly 320. The thermal storage assembly 320 may be formed in any suitable configuration for storing thermal energy therein, such as thermal energy of the working fluid 110.

The thermal storage assembly 320 may include any suitable storage media, such as a heat storage media. In a non-limiting example the heat storage media may comprise a HexPak Heat Transfer Media commercially available by Saint-Gobain NorPro of 3840 Fishcreek Rd. Stow, Ohio 44224, USA, for example.

As described in the background, conventionally, the thermal storage assembly 320 is placed in the ambient environment, out of the fluid conduit system 300. In accordance with an embodiment of the present disclosure, as seen in FIGS. 3A-4, the thermal storage assembly 320 is placed within the fluid channel 310 at a distance from an inner surface 360 of the pipe 312. The distance may comprise any suitable distance, which allows the working fluid 110 to surround the thermal storage assembly 320 for minimizing heat losses from the thermal storage assembly 320.

In some embodiments, the distance may be such that a sufficient volume of working fluid 110 may flow around the thermal storage assembly 320 to provide a sufficient amount of thermal energy for operation of the thermal energy consumption system. For example, the distance may be sized, such that a total area intermediate a housing 366 of the thermal storage assembly 320 and the inner surface 360 of the pipe 312 is at least the same size or larger than a cross sectional area of the heat exchanger assembly 340, thereby allowing a sufficient amount of thermal energy to be provided to the thermal energy consumption system.

Placing the thermal storage assembly 320 within the fluid channel 310 provides many advantages, as will be now described. Heat losses from the thermal storage assembly 320, placed within the fluid channel 310, are significantly less than the heat losses from a thermal storage assembly 320 placed within the ambient environment. This is due to the above ambient temperature of the working fluid 110 surrounding the thermal storage assembly 320 within the fluid channel 310.

Additionally, there may be times when the thermal energy source is unable to heat the working fluid 110 to the first temperature, such as the working temperature. Nevertheless, the temperature of the working fluid 110 still remains above ambient temperature, due to the thermal insulation layer 318. Accordingly, the heat losses from the thermal storage assembly 320 are still significantly less than the heat losses from a thermal storage assembly 320 placed within the ambient environment.

Moreover, when the thermal energy source resumes to heat the working fluid 110 to the working temperature, the temperature within the thermal storage assembly 320 may be required to be raised to the working temperature for allowing the thermal storage assembly 320 to commence its operation. For example, wherein the thermal storage assembly 320 comprises a storage media, the storage media may be heated to the working temperature in order to commence the operation of the thermal storage assembly 320. Therefore, when the thermal storage assembly 320 is placed within the fluid channel 310, significantly less thermal energy from the working fluid 110 is required for raising the temperature within the thermal storage assembly 320 to the working temperature, than the thermal energy required, when placed within the ambient environment.

Furthermore, the same working fluid 110 flows in the fluid channel 310 and through the thermal storage assembly 320. Therefore, there is substantially a minimal pressure difference between: within the thermal storage assembly 320 and therearound, as opposed to a pressure difference between: the ambient environment and within a thermal storage assembly 320 placed in the ambient environment. Accordingly, whereas a pressure resistant housing is required for a thermal storage assembly 320 placed in the ambient environment, the thermal storage assembly 320 placed within the fluid channel 310 does not require a pressure resistant housing. In a non-limiting example, the housing 366 of the thermal storage assembly 320 placed in the fluid channel 310 may be formed with up to a 30%, or a 50% or even a 70% reduced thickness than a thickness of a pressure resistance housing of a thermal storage assembly 320 placed in the ambient environment. Additionally, due to the minimal pressure difference between: within the thermal storage assembly 320 and therearound, anchoring the housing 366 to the pipe 312 is relatively simple, without requiring pressure resistant anchoring. In a non-limiting example, the thermal storage assembly 320 may be anchored to the inner surface 360 of the pipe 312 at any suitable location by rods 368.

In accordance with an embodiment of the present disclosure, any suitable device may be placed within the fluid channel 310 in place of the thermal storage assembly 320. Such a device may be configured to utilize the thermal energy of the working fluid 110 for any selected operation. The device, when placed within the fluid channel 310, losses less heat than when being placed in the ambient environment. The pressure difference within the device and the working fluid 110 is substantially minimal or negligible and significantly less than a pressure difference between the ambient environment and within a device placed in the ambient environment.

In a non-limiting example, the device may be a steam boiler, a heat recovery steam generator, a furnace, a pressure vessel, or a reactor vessel.

As seen in the embodiment of FIGS. 3A-4, wherein the device comprises the thermal storage assembly 320, the selected operation may be providing thermal energy to the thermal energy consumption system, wherein the thermal energy source is unable to heat the working fluid 110 to the working temperature.

In some embodiments, the device may use the thermal energy of the working fluid 110 for a selected operation unrelated to the thermal energy consumption system. For example, wherein the thermal energy source is a solar energy system and the thermal energy consumption system is a steam turbine, the device may comprise a chemical reactor and may be used for performing a chemical reaction unrelated to the steam turbine.

In some embodiments, the device may be placed centrally within the fluid channel 310, as shown in FIGS. 3A-3C. In some embodiments, the device may be placed at a greater proximity to the inner surface 360 of a first side 370 of the pipe 312 than a second side 372 thereof. In some embodiments, the device may be in contact with one of the sides 370 or 372 and the working fluid 110 may surround the device at the opposite side. The device may be placed in any suitable location along the fluid channel 310.

The distance between the device and the pipe 312 may be any suitable distance to allow the working fluid 110 to surround at least a portion of the device. In some embodiments, the distance may be such that a sufficient volume of working fluid 110 may flow around the device to provide a sufficient amount of thermal energy for operation of the thermal energy consumption system.

In some embodiments, apparatuses (not shown) for controlling the operation of the device and flow of the working fluid 110 may be provided. For example, temperature and pressure sensors may be provided to measure the temperature of the working fluid 110 within the device. Additionally, the blower 350, pumps, valves, shutters or dampers may be provided to control the flow of the working fluid 110 within the fluid channel 310 and the device and/or control the flow of the heat transfer fluid 344 within the inlet conduit 346 and outlet conduit 348. These apparatuses may be electrically or mechanically operated or in any other suitable manner and may communicate with a control system (not shown) in any suitable manner. The control system may be placed out of the fluid conduit system 300, or may be placed within the fluid conduit system 300.

In a non-limiting example, wherein the apparatuses are electrically operated, an electrical conduit comprising electrical wires (not shown), may be inserted within bores formed in the respective thermal insulation layer 318, and/or pipe 312 for providing electrical communication between the apparatuses within the fluid channel 310 and with the control system, when placed out of the fluid conduit system 300.

The operational modes of the thermal storage assembly 320 are described in FIGS. 3A-3C. It is seen that during the different operational modes the heat loss from the thermal storage assembly 320 is minimized by the working fluid 110 flowing therearound.

Turning to FIG. 3A, a first operational mode is shown wherein thermal energy of the working fluid 110 is stored within the thermal storage assembly 320, generally at a working temperature. Prior to introducing the working fluid 110 into the thermal storage assembly 320, there may be residual working fluid 110 remaining therein, generally at a relatively low temperature, such as in the range of 25-400° C., or in the range of 25-250° C. The residual working fluid 110 may be removed from the thermal storage assembly 320, prior to introduction of the working fluid 110 at the working temperature therein. The residual working fluid 110 may flow out of the thermal storage assembly 320 via a bypass channel 380 and a bypass channel valve 384, shown in an open state. The bypass channel valve 384 may be placed at any suitable location along the bypass channel 380. The residual working fluid 110 may flow from bypass channel 380 to the fluid channel 310, via a conduit 386.

Conduit 386 may extend from an opening 388, placed upstream the thermal storage assembly 320, to an opening 390, placed downstream the heat exchanger assembly 340. The conduit 386 may be provided to allow the working fluid 110 to flow in the fluid conduit assembly 300 while bypassing the heat exchanger assembly 340 and the thermal storage assembly 320, when flowing from opening 390 to opening 388, as shown in FIG. 3C. Additionally, the conduit 386 may be provided to allow the working fluid 110 to flow in the fluid conduit assembly 300 while bypassing the heat exchanger assembly 340, when flowing from bypass channel 380 to opening 390, as shown in FIG. 3A. A conduit valve 392 may be provided at opening 388, or any other suitable location, for controlling the flow of the working fluid 110 within the conduit 386.

The working fluid 110, at the first temperature, may enter the fluid channel 310 from the thermal energy source, via a fluid channel valve 394, shown in FIG. 3A in an open state. A portion of the working fluid 110 may be directed to flow into the thermal storage assembly 320, via a first storage valve 398, here shown in an open state. The thermal energy from the working fluid 110 is stored within the thermal storage assembly 320, which may be enclosed by a second storage valve 400, which is shown in FIG. 3A in a closed state. A remaining portion of the working fluid 110, at the first temperature may flow around the thermal storage assembly 320 into the heat exchanger assembly 340. As described above, the working fluid 110 may be used to heat the heat transfer fluid 344 fluid flowing into the heat exchanger assembly 340, via inlet conduit 346.

The remaining portion of the working fluid 110 flowing around the thermal storage assembly 320 ensures that the heat losses from the thermal storage assembly 320 are minimized and significantly less than the heat losses from a thermal storage assembly 320 placed in the ambient environment.

The working fluid 110 may exit the beat exchanger assembly 340 at the second temperature, which may be lower than the working temperature, though still above ambient temperature. The now cooler working fluid 110 may flow on within the fluid channel 310. Wherein the fluid conduit system 300 is a closed-loop system, the cooler working fluid 110 may flow back to the thermal energy source for reheating thereof. Wherein the fluid conduit system 300 is an open-loop system, the cooler working fluid 110 may flow to any other location.

Turning to FIG. 3B, a second operational mode or a “standby” mode is shown. In this standby mode the thermal storage assembly 320 is generally fully heated by the thermal energy of the working fluid 110 and remains therein while working fluid 110 continues to enter the fluid channel 310 at the first temperature, such as the working temperature, via fluid channel valve 394, shown in FIG. 3B in an open state. The second storage valve 400, may remain in a closed state. Since there is no residual working fluid 110 to be removed from the thermal storage assembly 320, the bypass valve 384 may be positioned in a closed state.

Since the thermal storage assembly 320 is generally fully heated, the first storage valve 398 may be closed since there is no need to further introduce hot working fluid 110 therein. In some embodiments first storage valve 398 may be fully or partially open and the hot working fluid 110 may flow therein generally without affecting the heat stored in the thermal storage assembly 320, as seen in FIG. 313.

As described in reference to FIG. 3A, working fluid 110 at the first temperature may flow around the thermal storage assembly 320 into the heat exchanger assembly 340. As described above, the working fluid 110 may be used to heat the heat transfer fluid 344 flowing into the heat exchanger assembly 340, via inlet conduit 346. The working fluid 110 may exits the heat exchanger assembly 340 at a relatively low temperature, and flow thereout, as described in reference to FIG. 3A.

The working fluid 110 flowing around the thermal storage assembly 320 ensures that the heat losses from the thermal storage assembly 320 are minimized and significantly less than the heat losses from a thermal storage assembly 320 placed in the ambient environment.

Turning to FIG. 3C, a third operational mode is shown wherein thermal energy is discharged from the thermal storage assembly 320 and is utilized to heat working fluid 110 flowing in the fluid channel 310, wherein the working fluid 110 flows therein below the first temperature, such as below the working temperature.

The fluid channel valve 394 may be closed so as to prevent relatively cool working fluid 110 from flowing into fluid channel 310 from the thermal energy source. An additional fluid channel valve 410 may be closed so as to direct the working fluid 110 to flow via conduit 386 into the thermal storage assembly 320 via the conduit valve 392, shown in an open state. The relatively cool working fluid 110 flowing through and around the thermal storage assembly 320 may be heated by the stored thermal energy in the thermal storage assembly 320 to the first temperature, such as the working temperature. The now heated working fluid 110 may flow to the heat exchanger assembly 340 for providing thermal energy to the thermal energy consumption system.

In another embodiment the fluid channel valves 394 and 410 may be open and working fluid 110, below the first temperature, may flow from the thermal energy source to the central fluid channel 106.

The third operational mode may be operated wherein the thermal energy source is unable to provide sufficient thermal energy to heat the working fluid 110 to the first temperature. For example, wherein the thermal energy source is a solar energy system, this may occur during the evening or at cloudy times during the day. At these times the stored thermal energy in the thermal storage assembly 320 may be utilized to heat the working fluid 110 to the first temperature, thereby allowing the thermal energy consumption system to continue receiving the thermal energy for operation thereof.

There may be an additional mode wherein the fluid conduit system 100 is inoperative and the fluid channel valves 394 and 410 are closed, such as shown in FIG. 3C. The flow of the heat transfer fluid 344 within the heat exchanger assembly 320 may be halted. For example, wherein the thermal energy source is a solar energy system, this may occur during nighttime. In this mode, in some embodiments, the working fluid 110 may circulate within the fluid channel 310 and conduit 386 by urging of the blower 350 and wherein the conduit valve 392 is open. In some embodiments the blower 350 may be inoperative and the working fluid 110 may be substantially static within the fluid channel 310 and the conduit valve 392 may be closed. In embodiments, wherein the working fluid 110 is circulated or static, the working fluid 110 surrounding the thermal storage assembly 320 is above ambient temperature and thus minimizes heat losses from the thermal storage assembly 320, than would have occurred had the thermal storage assembly 320 been placed within the ambient environment

When the thermal energy source resumes to heat the working fluid 110 to the first temperature, the temperature within the thermal storage assembly 320 may be required to be raised to the working temperature for allowing the thermal storage assembly 320 to commence its operation. For example, wherein the thermal energy source is a solar energy system, this may occur at morning. Therefore, when the thermal storage assembly 320 is placed within the fluid channel 310, significantly less thermal energy from the working fluid 110 is required for raising the temperature within the thermal storage assembly 320 to the working temperature, than the thermal energy required, when placed within the ambient environment.

Reference is now made to FIG. 4, which is an exemplary solar energy system comprising the fluid conduit system 300 of FIGS. 3A-3C and shown in the first operative mode of FIG. 3A. In FIG. 4 the thermal energy source is the solar thermal energy system 200 shown in FIG. 2.

Hot working fluid 110 exits the receiver 222 and may flow into the fluid channel 310 at the first temperature. In a non-limiting example, the hot working fluid 110 flows in the fluid channel 310 at a range of 400-1000° C., such as 600° C. A portion of the hot working fluid 110 may flow into the thermal storage assembly 320 for storing the thermal energy therein. The other portion of the hot working fluid 110 may flow to the heat exchanger assembly 340, which may use the thermal energy of the hot working fluid 110 to heat the heat transfer fluid 344 flowing in the inlet conduit 346. In a non-limiting example, the heat transfer fluid 344 flows into the heat exchanger at a temperature of approximately 50° C. and is heated to a temperature of approximately 540° C. The heated heat transfer fluid 344 may flow out of the heat exchanger assembly 340, via the outlet conduit 348, to a thermal energy consumption system. As seen in FIG. 4, the thermal energy consumption system comprises the steam turbine 240. The heat transfer fluid 344 may flow back into the inlet conduit 346 from the steam turbine 240.

The now cooled working fluid 110 flows out of the heat exchanger assembly 340 at the second temperature. In a non-limiting example, the cooled working fluid 110 flows out of the heat exchanger assembly 340 at temperature in a range of 100-350° C.

The cooled working fluid 110 may flow, via a fluid conduit 420 back to the solar receiver 222, for being reheated therein, as shown in FIG. 4, or may flow to any other suitable location.

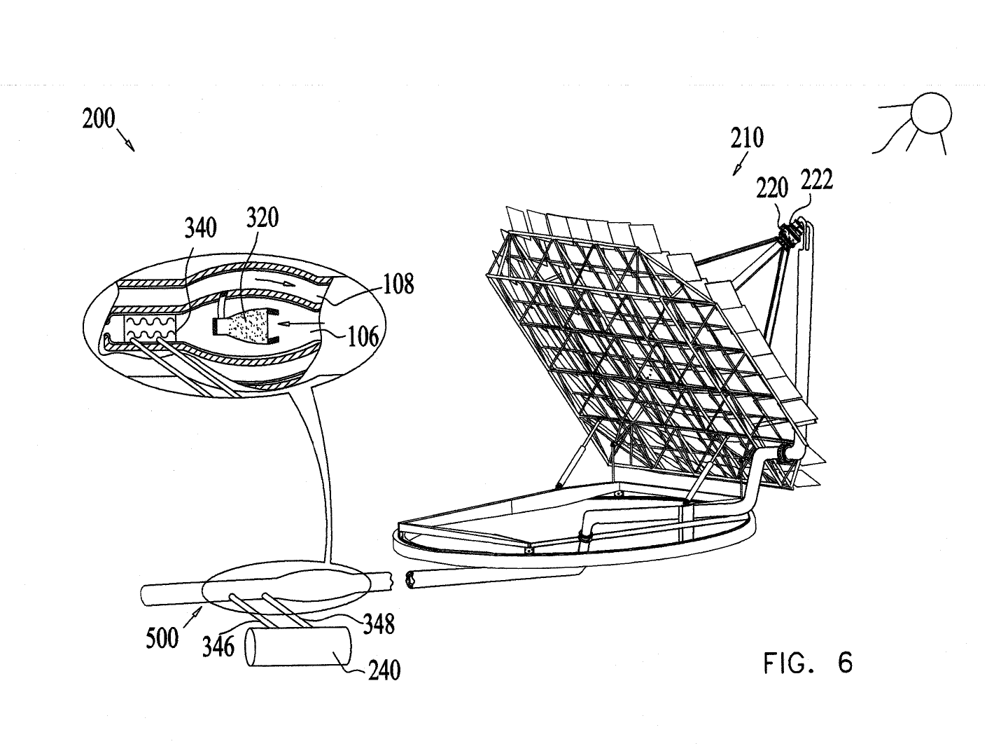

The embodiments of FIGS. 1-4 show exploiting: (i) the working fluid 110, which flows in the fluid conduit system 100 or fluid conduit system 300 during the course of its operation (i.e. from the thermal energy source to the thermal energy consumption system and back), and for exploiting (ii) an already existing thermally insulated fluid conduit system 100 or fluid conduit system 300, for minimizing heat losses from the device. Similarly, the embodiments of FIGS. 5A-6 show exploiting (i) the working fluid 110, which flows in a fluid conduit system 500 during the course of its operation, and for exploiting (ii) an already thermally insulated existing annulus assembly 102 for preventing heat losses from a device.

In the embodiments of FIGS. 5A-6 the heat loss is minimized by both the working fluid 110 flowing at the second temperature in a circumferential fluid channel 508 and by the central and circumferential thermal insulation layers 522 and 532, as in FIGS. 1 and 2, and by the working fluid 110 flowing within a central fluid channel 506 and surrounding the device at an above ambient temperature, similar to FIGS. 3A-4.

In FIGS. 5A-6, the device shown is the thermal storage assembly 320, though it is appreciated that any suitable device may be placed within the central fluid channel 106 for minimizing the heat losses therefrom.

As seen in FIGS. 5A-5C, the fluid conduit system 500 comprises an annulus assembly 502. The annulus assembly 502 is similar to annulus assembly 102, yet in the annulus assembly 502 the central pipe 126 and circumferential pipe 120 may bow out at a section 510 surrounding the thermal storage assembly 320 so as to allow the working fluid 110 to flow therearound. It is appreciated that the central pipe 126 and circumferential pipe 120 may be formed without section 510 and the working fluid 110 may flow around the thermal storage assembly 320 in any suitable manner. For example, section 510 may be substantially straight and the central pipe 126 and circumferential pipe 120 may be sufficiently large to allow the working fluid 110 to flow around a device within the central fluid channel 106.

The working fluid 110 may flow within the central fluid channel 106 at a relatively high temperature, such as in the range of 150-1000° C., for example. The working fluid 110 may be heated by the thermal energy source to the first temperature, such as the working temperature, prior to entering the fluid conduit assembly 500. The thermal energy source may be any suitable source, as described in reference to FIGS. 1 and 2. An exemplary solar energy system will be described in reference to FIG. 6. Thermal energy of the working fluid may be provided to the thermal energy consumption system for operation thereof, such as the thermal energy consumption system described in reference to FIGS. 1 and 2.

The thermal energy of the working fluid 110 may be provided to the thermal energy consumption system in any suitable manner, such as by the heat exchanger assembly 340 or any other suitable device for providing the working fluid thermal energy to the thermal energy consumption system.

In accordance with some embodiments, the heat transfer fluid 344 may flow into the heat exchanger assembly 340, via the inlet conduit 346, to be heated within the heat exchanger assembly 340 by the working fluid thermal energy. The heated heat transfer fluid 344 may flow out of the heat exchanger assembly 340, via outlet conduit 348, and may flow to the thermal energy consumption system.

The working fluid 110 may exit the heat exchanger assembly 340 at the second temperature, which may be lower than the working temperature, though still above ambient temperature. The pump, fan or blower 350, or any other suitable device, may be provided for directing the now cooled working fluid 110 to flow from the heat exchanger assembly 340 thereout.

The cooled working fluid 110 may flow through the circumferential fluid channel 108 and thereout. Wherein the fluid conduit system 500 is a closed-loop system, the cooler working fluid may flow back to the thermal energy source for reheating thereof. Wherein the fluid conduit system 500 is an open-loop system, the cooler working fluid may flow to any other location.

The heat exchanger assembly 340 may be in fluid communication with the thermal storage assembly 320. The thermal storage assembly 320 may be formed in any suitable configuration for storing thermal energy therein, such as thermal energy of the working fluid 110.

As described in the background, conventionally, the thermal storage assembly 320 is placed in the ambient environment, out of the fluid conduit system 500. In accordance with an embodiment of the present disclosure, as seen in FIGS. 5A-6, the thermal storage assembly 320 is placed within the central fluid channel 106 at a distance from an inner surface 520 of the central pipe 106 or central thermal insulation layer 122. The distance may comprise any suitable distance, which allows the working fluid 110 to surround the thermal storage assembly 320 for minimizing heat losses from the thermal storage assembly 320.

In some embodiments, the distance may be such that a sufficient volume of working fluid 110 may flow around the thermal storage assembly 320 to provide a sufficient amount of thermal energy for operation of the thermal energy consumption system. For example, the distance may be sized, such that a total area intermediate the housing 366 of the thermal storage assembly 320 and the inner surface 520 is at least the same size or larger than a cross sectional area of the heat exchanger assembly 340, thereby allowing a sufficient amount of thermal energy to be provided to the thermal energy system.

Placing the thermal storage assembly 320 within the central fluid channel 106 provides many advantages, as will be now described. Heat losses from the thermal storage assembly 320, placed within the central fluid channel 106, are significantly less than the heat losses from a thermal storage assembly 320 placed within the ambient environment. This is due to the following: (i) the above ambient temperature of the working fluid 110 surrounding the thermal storage assembly 320 within the central fluid channel 106 (ii) the above ambient temperature of the cooled working fluid 110 flowing in the circumferential fluid channel 108 at the second temperature and (iii) may also be due to the central and/or circumferential thermal insulation layers 122 and 132.

Additionally, there may be times when the thermal energy source is unable to heat the working fluid 110 to the working temperature. During these times, the heat exchanger assembly 340 may at times halt its operation and cease to provide thermal energy to the thermal energy consumption system. For example, wherein the thermal energy source is a solar energy system, this may occur at night. Nevertheless, the temperature of both the working fluid 110 within the circumferential fluid channel 108 and within the central fluid channel 106 still remains above ambient temperature, due to the circumferential thermal insulation layer 132. Accordingly, the heat losses from the thermal storage assembly 320 are still significantly less than the heat losses from a thermal storage assembly 320 placed within the ambient environment.

Moreover, when the thermal energy source resumes to heat the working fluid 110 to the working temperature, the temperature within the thermal storage assembly 320 may be required to be raised to the working temperature for allowing the thermal storage assembly 320 to commence its operation. For example, wherein the thermal storage assembly 320 comprises a storage media, the storage media may be heated to the working temperature in order to commence the operation of the thermal storage assembly 320. Therefore, when the thermal storage assembly 320 is placed within the central fluid channel 106, significantly less thermal energy from the working fluid 110 is required for raising the temperature within the thermal storage assembly 320 to the working temperature, than the thermal energy required, when placed within the ambient environment.

Furthermore, as described above, within the annulus assembly 102 there is fluid communication between the working fluid 110 flowing in the central fluid channel 106 at the first temperature and the working fluid 110 flowing in the circumferential fluid channel 108 at the second temperature. Additionally, the same working fluid 110 flows in the central fluid channel 106 and through the thermal storage assembly 320. Accordingly, the pressure difference within the heat exchanger assembly 340 and the working fluid 110 within the central fluid channel 106 and the circumferential fluid channel 108 is substantially minimal or negligible and significantly less than a pressure difference between the ambient environment and within a heat exchanger assembly 340 placed in the ambient environment. Similarly, the pressure difference within the thermal storage assembly 320 and the working fluid 110 within the central fluid channel 106 and the circumferential fluid channel 108 is substantially minimal or negligible and significantly less than a pressure difference between the ambient environment and within a thermal storage assembly 320 placed in the ambient environment.

Accordingly, whereas a pressure resistant housing is required for a thermal storage assembly 320 placed in the ambient environment, the thermal storage assembly 320 placed within the annulus assembly 502 does not require a pressure resistant housing. In a non-limiting example, the housing 366 of the thermal storage assembly 320 placed in the annulus assembly 502 may be formed with up to a 30%, or a 50% or even a 70% reduced thickness than a thickness of a pressure resistance housing of a thermal storage assembly 320 placed in the ambient environment. Additionally, due to the minimal pressure difference between: within the thermal storage assembly 320 and therearound, anchoring the housing 366 to the pipe 312 is relatively simple, without requiring pressure resistant anchoring. In a non-limiting example, the thermal storage assembly 320 may be anchored to the inner surface 360 of the pipe 312 at any suitable location by rods 368.

Similarly, whereas a pressure resistant housing is required for a heat exchanger assembly 340 placed in the ambient environment, the heat exchanger assembly 340 placed within the annulus assembly 502 does not require a pressure resistant housing.

Moreover, when placing the heat exchanger assembly 340 and/or the thermal storage assembly 320 in the ambient environment, a fluid conduit is required to direct the working fluid 110 at the first temperature to flow from central fluid channel 106 to the heat exchanger assembly 340 and/or the thermal storage assembly 320 and an additional fluid conduit is required to direct the working fluid 110 at the second temperature from the heat exchanger assembly 340 and/or the thermal storage assembly 320 to the circumferential fluid channel 108. By placing the heat exchanger assembly 340 and/or the thermal storage assembly 320 within the central fluid channel 106 both fluid conduits are unnecessary.

In accordance with an embodiment of the present disclosure, any suitable device may be placed within the annulus assembly 502 in place of the thermal storage assembly 320. Such a device may be configured to utilize the thermal energy of the working fluid 110 for any selected operation. The device, when placed within the annulus assembly 502, losses less heat than when being placed in the ambient environment. The pressure difference within the device and the working fluid 110 is substantially minimal or negligible and significantly less than a pressure difference between the ambient environment and within a device placed in the ambient environment.

In a non-limiting example, the device may be a steam boiler, a heat recovery steam generator, a furnace, a pressure vessel, or a reactor vessel.

As seen in the embodiment of FIGS. 5A-6, wherein the device comprises the thermal storage assembly 320, the selected operation may be providing thermal energy to the thermal energy consumption system, wherein the thermal energy source is unable to heat the working fluid 110 to the working temperature.

In some embodiments, the device may use the thermal energy of the working fluid 110 for a selected operation unrelated to the thermal energy consumption system. For example, wherein the thermal energy source is a solar energy system and the thermal energy consumption system is a steam turbine, the device may comprise a chemical reactor and may be used for performing a chemical reaction unrelated to the steam turbine.

In some embodiments, the device may be placed centrally within the central fluid channel 106, as shown in FIGS. 5A-5C. In some embodiments, the device may be placed at a greater proximity to the inner surface 520 of a first side 530 of the central pipe 126 than a second side 532 thereof. In some embodiments, the device may be in contact with one of the sides 530 or 532 and the working fluid 110 may surround the device at the opposite side. The device may be placed in any suitable location along the annulus assembly 502.

The distance between the device and the central pipe 126 may be any suitable distance to allow the working fluid 110 to surround at least a portion of the device. In some embodiments, the distance may be such that a sufficient volume of working fluid 110 may flow around the device to provide a sufficient amount of thermal energy for operation of the thermal energy consumption system.

In some embodiments the device may be placed within the circumferential fluid channel 108 or any suitable location within the annulus assembly 502.

In some embodiments, apparatuses (not shown) for controlling the operation of the device and flow of the working fluid 110 may be provided. For example, temperature and pressure sensors may be provided to measure the temperature of the working fluid 110 within the device and within the annulus assembly 502. Additionally, the blower 350, pumps, valves, shutters or dampers may be provided to control the flow of the working fluid 110 within the annulus assembly 502 and the device and/or control the flow of the heat transfer fluid 344 within the inlet conduit 346 and outlet conduit 348. These apparatuses may be electrically or mechanically operated or in any other suitable manner and may communicate with a control system (not shown) in any suitable manner. The control system may be placed out of the annulus assembly 502, or may be placed within the annulus assembly 502.

In a non-limiting example, wherein the apparatuses are electrically operated, an electrical conduit comprising electrical wires (not shown), may be inserted within bores formed in the respective thermal insulation layer 318, and/or pipe 312 for providing electrical communication between the apparatuses within the annulus assembly 502 and with the control system, when placed out of the annulus assembly 502.

The operational modes of the thermal storage assembly 320 are described in FIGS. 5A-5C. It is seen that during the different operational modes the heat loss from the thermal storage assembly 320 is minimized by the working fluid 110 flowing therearound and by the working fluid 110 flowing in the circumferential fluid channel 108 and possibly also by the central and/or circumferential thermal insulation layers 122 and 132.

Turning to FIG. 5A, a first operational mode is shown wherein thermal energy of the working fluid 110 is stored within the thermal storage assembly 320, generally at a working temperature. Prior to introducing the working fluid 110 into the thermal storage assembly 320, there may be residual working fluid 110 remaining therein, generally at a relatively low temperature, such as in the range of 25-400° C., or in the range of 25-250° C. The residual working fluid 110 may be removed from the thermal storage assembly 320, prior to introduction of the working fluid 110 at the working temperature therein. The residual working fluid 110 may flow out of the thermal storage assembly 320 via bypass channel 380 and bypass channel valve 384, shown in an open state. The bypass channel valve 384 may be placed at any suitable location along the bypass channel 380. The residual working fluid 110 may flow from bypass channel 380 into the circumferential fluid channel 108.

The working fluid 110, at the first temperature, may enter the central fluid channel 106 from the thermal energy source, via a fluid channel valve in an open state and may be typically placed an entrance of the annulus system 502 (not shown). A portion of the working fluid 110 may be directed to flow into the thermal storage assembly 320, via the first storage valve 398, here shown in an open state. The thermal energy from the working fluid 110 is stored within the thermal storage assembly 320, which may be enclosed by the second storage valve 400, which is shown in FIG. 5A in a closed state. A remaining portion of the working fluid 110, at the first temperature may flow around the thermal storage assembly 320 into the heat exchanger assembly 340. As described above, the working fluid 110 may be used to heat the heat transfer fluid 344 fluid flowing into the heat exchanger assembly 340, via inlet conduit 346.

The remaining portion of the working fluid 110 flowing around the thermal storage assembly 320 ensures that the heat losses from the thermal storage assembly 320 are minimized and significantly less than the heat losses from a thermal storage assembly 320 placed in the ambient environment. Additionally, the working fluid 110 flowing in the circumferential fluid channel 108 and possibly also the central and/or circumferential thermal insulation layers 122 and 132 ensure that the heat losses from the thermal storage assembly 320 are minimized and are significantly less than the heat losses from a thermal storage assembly 320 placed in the ambient environment.

The working fluid 110 may exit the heat exchanger assembly 340 at the second temperature, which may be lower than the working temperature, though still above ambient temperature. The now cooler working fluid 110 may be directed to flow into the circumferential fluid channel 108. Wherein the fluid conduit system 500 is a closed-loop system, the cooler working fluid 110 may flow back to the thermal energy source for reheating thereof. Wherein the fluid conduit system 500 is an open-loop system, the cooler working fluid 110 may flow to any other location.

Turning to FIG. 5B, a second operational mode or a “standby” mode is shown. In this standby mode the thermal storage assembly 320 is generally fully heated by the thermal energy of the working fluid 110 and remains therein while working fluid 110 continues to enter the central fluid channel 106 at a the first temperature, such as the working temperature. The second storage valve 400, may remain in a closed state. Since there is no residual working fluid 110 to be removed from the thermal storage assembly 320, the bypass valve 384 may be positioned in a closed state.

Since the thermal storage assembly 320 is generally fully heated, the first storage valve 398 may be closed since there is no need to further introduce hot working fluid 110 therein. In some embodiments first storage valve 398 may be fully or partially open and the hot working fluid 110 may flow therein generally without affecting the heat stored in the thermal storage assembly 320, as seen in FIG. 5B.

As described in reference to FIG. 5A, working fluid 110 at the first temperature may flow around the thermal storage assembly 320 into the heat exchanger assembly 340. As described above, the working fluid 110 may be used to heat the heat transfer fluid 344 fluid flowing into the heat exchanger assembly 340, via inlet conduit 346. The working fluid 110 may exits the heat exchanger assembly 340 at a relatively low temperature, and flow thereout, as described in reference to FIG. 5A.

The working fluid 110 flowing around the thermal storage assembly 320 ensures that the heat losses from the thermal storage assembly 320 are minimized and significantly less than the heat losses from a thermal storage assembly 320 placed in the ambient environment. Additionally, the working fluid 110 flowing in the circumferential fluid channel 108 and possibly also the central and/or circumferential thermal insulation layers 122 and 132 ensure that the heat losses from the thermal storage assembly 320 are minimized and are significantly less than the heat losses from a thermal storage assembly 320 placed in the ambient environment.

Turning to FIG. 5C, a third operational mode is shown wherein thermal energy is discharged from the thermal storage assembly 320 and is utilized to heat working fluid 110 flowing in the central fluid channel 106, wherein the working fluid 110 flows therein below the first temperature, such as below the working temperature.

The fluid channel valve (not shown) may be closed so as to prevent relatively cool working fluid 110 from flowing into central fluid channel 106 from the thermal energy source and allow the working fluid 110 to flow from the circumferential fluid channel 108 to the central fluid channel 106. The relatively cool working fluid 110 flowing through and around the thermal storage assembly 320 may be heated by the stored thermal energy in the thermal storage assembly 320 to the first temperature, such as the working temperature. The now heated working fluid 110 may flow to the heat exchanger assembly 340 for providing thermal energy to the thermal energy consumption system.

In another embodiment the fluid channel valve may be open and working fluid 110, below the first temperature, may flow from the thermal energy source to the central fluid channel 106.

The third operational mode may be operated wherein the thermal energy source is unable to provide sufficient thermal energy to heat the working fluid 110 to the first temperature. For example, wherein the thermal energy source is a solar energy system, this may occur during the evening or at cloudy times during the day. At these times the stored thermal energy in the thermal storage assembly 320 may be utilized to heat the working fluid 110 to the first temperature, thereby allowing the thermal energy consumption system to continue receiving the thermal energy for operation thereof.

There may be an additional operative mode wherein the fluid conduit system 500 is inoperative and the fluid channel valve (not shown) is closed. The flow of the heat transfer fluid 344 within the heat exchanger assembly 320 may be halted. For example, wherein the thermal energy source is a solar energy system, this may occur during nighttime. In this mode, in some embodiments, the working fluid 110 may circulate within the annulus assembly 502 by urging of the blower 350. In some embodiments the blower 350 may be inoperative and the working fluid 110 may be substantially static within the annulus assembly 502. In embodiments, wherein the working fluid 110 is circulated or static, the working fluid 110, surrounding the thermal storage assembly 320 and within the circumferential fluid channel 108, is above ambient temperature. Thus there are less heat losses from the thermal storage assembly 320, than would have occurred had the thermal storage assembly 320 been placed within the ambient environment

When the thermal energy source resumes to heat the working fluid 110 to the first temperature, the temperature within the thermal storage assembly 320 may be required to be raised to the working temperature for allowing the thermal storage assembly 320 to commence its operation. For example, wherein the thermal energy source is a solar energy system, this may occur at morning. Therefore, when the thermal storage assembly 320 is placed within the annulus assembly 502, significantly less thermal energy from the working fluid 110 is required for raising the temperature within the thermal storage assembly 320 to the working temperature, than the thermal energy required, when placed within the ambient environment.

Reference is now made to FIG. 6, which is an exemplary solar energy system comprising the fluid conduit system 500 of FIGS. 5A-5C and shown in the first operative mode of FIG. 5A. In FIG. 6 the thermal energy source is the solar thermal energy system 200 shown in FIG. 2.

Hot working fluid 110 exits the receiver 222 and may flow into the central fluid channel 106 at the first temperature. In a non-limiting example, the hot working fluid 110 flows in the central fluid channel 106 at a range of 400-1000° C., such as 600° C. A portion of the hot working fluid 110 may flow into the thermal storage assembly 320 for storing the thermal energy therein. The other portion of the hot working fluid 110 may flow to the heat exchanger assembly 340, which may use the thermal energy of the hot working fluid 110 to heat the heat transfer fluid 344 flowing in the inlet conduit 346. In a non-limiting example, the heat transfer fluid 344 flows into the heat exchanger at a temperature of approximately 50° C. and is heated to a temperature of approximately 540° C. The heated heat transfer fluid 344 may flow out of the heat exchanger assembly 340, via the outlet conduit 348, to a thermal energy consumption system. As seen in FIG. 6, the thermal energy consumption system comprises the steam turbine 240. The heat transfer fluid 344 may flow back into the inlet conduit 346 from the steam turbine 240.

The now cooled working fluid 110 flows out of the heat exchanger assembly 340 at the second temperature. In a non-limiting example, the cooled working fluid 110 flows out of the heat exchanger assembly 340 at temperature in a range of 100-350° C.

The cooled working fluid 110 may flow, via the circumferential fluid channel 108, back to the solar receiver 222, for being reheated therein, as shown in FIG. 6, or may flow to any other suitable location.

It is noted that in the embodiments of FIGS. 1-6, the working fluid 110 may at times be static and not flow within the fluid conduit system. For example, wherein the fluid conduit system is inoperative (such as at nighttime wherein the thermal energy source in the solar energy system). Even at this time the working fluid 110 surrounds the device and thereby minimizes the heat loss from the device placed within the fluid conduit system. In the embodiment of FIGS. 1 and 2 the working fluid 110 is within the circumferential fluid channel 108 and thus surrounds the device. In the embodiment of FIGS. 3A-4 the working fluid 110 is within the fluid channel 310 which is configured for having the working fluid 110 surround the device. In the embodiment of FIGS. 5A-6 the working fluid 110 is within the circumferential fluid channel 108 and thus surrounds the device and the working fluid 110 is within the central fluid channel 106 which is configured for having the working fluid 110 surround the device.

Example embodiments of the methods and components of the current subject matter have been described herein. As noted elsewhere, these example embodiments have been described for illustrative purposes only, and are not limiting. Other embodiments are possible and are covered by the current subject matter. Such embodiments will be apparent to persons skilled in the relevant art(s) based on the teachings contained herein. Thus, the breadth and scope of the current subject matter should not be limited by any of the above-described exemplary embodiments, but should be defined only in accordance with the following claims and their equivalents.

1-49. (canceled)

50. A fluid conduit system, comprising:
a first channel having a closed end and an open end;
a second channel positioned in the first channel, wherein the second channel has an entrance and an exit, wherein the exit is spaced apart from the closed end of the first channel; and
at least one device positioned in the second channel having fluid communication outside of the fluid conduit system,
wherein a working fluid introduced into the entrance of the second channel passes therethrough and out of the exit toward the closed end of the first channel and out of the open end.

51. The system of claim 50, further comprising at least a portion of a layer of thermal insulation between the second channel and the first channel.

52. The system of claim 50, further comprising at least a portion of a layer of thermal insulation between the working fluid and an ambient environment.

53. The system of claim 50, wherein the device comprises a heat exchanger assembly.

54. The system of claim 50, wherein the device comprises a thermal storage assembly.

55. The system of claim 50, wherein the device comprises a thermal storage assembly and a heat exchanger assembly.

56. The system of claim 55, further comprising a bypass channel for allowing the working fluid to bypass the heat exchanger assembly.

57. The system of claim 50, wherein the device comprises at least one of: a thermal storage assembly, a heat exchanger assembly, a steam boiler, a heat recovery steam generator, a furnace, a pressure vessel, or a reactor vessel.

58. The system of claim 50, wherein a heat transfer fluid is provided to transfer the thermal energy from the working fluid to the thermal energy consumption system.

59. The system of claim 50, wherein the fluid communication outside of the fluid conduit system is with a thermal energy source provided to heat the working fluid.

60. The system of claim 59, wherein the thermal energy source comprises a solar energy system.

61. The system of claim 50, wherein thermal energy supplied by the working fluid is used by a thermal energy consumption system.

62. The system of claim 61, wherein the thermal energy consumption system comprises a steam turbine, a vapor turbine, a gas turbine, an industrial system, a vapor consuming process, a dryer, a solid desiccant system, or an absorption refrigerator.

63. The system of claim 50, further comprising a control system for controlling flow of the working fluid within the fluid conduit system.

64. A fluid conduit system, comprising:
a fluid channel having an entrance for a working fluid flowing in a first direction at one end and an exit for the working fluid at an opposite end;
a device positioned in the fluid channel and configured for having the working fluid flow therearound; and
fluid communication between the device and outside the fluid channel,
wherein thermal energy supplied by the working fluid is used by a thermal energy consumption system.

65. The system of claim 64, further comprising an additional fluid channel surrounding the fluid channel adapted for receiving the working fluid exiting the fluid channel at a first direction and directing the working fluid in a second direction, opposite the first direction.

66. The system of claim 65, further comprising at least a portion of a layer of thermal insulation between the fluid channel and the additional fluid channel.

67. The system of claim 64, further comprising at least a portion of a layer of thermal insulation between the working fluid and an ambient environment.

68. The system of claim 64, wherein the device comprises a heat exchanger assembly.

69. The system of claim 64, wherein the device comprises a thermal storage assembly.

70. The system of claim 64, wherein the device comprises a thermal storage assembly and a heat exchanger assembly.

71. The system of claim 70, further comprising a bypass channel for allowing the working fluid to bypass the heat exchanger assembly.

72. The system of claim 64, wherein the fluid communication outside of the fluid channel is with a thermal energy source provided to heat the working fluid.

73. The system of claim 72, wherein the thermal energy source comprises a solar energy system.

74. A fluid conduit system, comprising:
a central fluid channel having an entrance for a working fluid flowing in a first direction at one end and an exit for the working fluid at an opposite end;
a circumferential fluid channel surrounding the central fluid channel adapted for receiving the working fluid exiting the central fluid channel and directing the working fluid in a second direction opposite the first direction;
at least one device positioned in the central fluid channel for having the working fluid flow therethrough; and
fluid communication between the device and outside the circumferential fluid channel, wherein thermal energy supplied by the working fluid is used by a thermal energy consumption system.
